(19) United States
(12) Patent Application Publication
(10) Pub. No.: US 2025/0276559 A1
(43) Pub. Date: Sep. 4, 2025

(54) INTEGRATED CONTROL SYSTEM FOR VEHICLE

(71) Applicant: Hanon Systems, Daejeon (KR)

(72) Inventors: Ho Beom KIM, Daejeon (KR); Jae Won LEE, Daejeon (KR)

(73) Assignee: Hanon Systems, Daejeon (KR)

(21) Appl. No.: 19/046,325

(22) Filed: Feb. 5, 2025

(30) Foreign Application Priority Data
Feb. 29, 2024 (KR) 10-2024-0030084

(51) Int. Cl. B60H 1/00

(52) U.S. Cl. CPC B60H 1/00885; B60H 1/0073

(57) ABSTRACT

The present invention relates to an integrated control system for a vehicle, and more particularly, to an integrated control system capable of controlling both a refrigerant module and a coolant module included in the vehicle in an integrated manner. The present invention aims to control the end devices of the connected coolant module and refrigerant module using a single control module.

### CROSS REFERENCE TO RELATED APPLICATION

The present application claims priority to Korean Patent Application No. 10-2024-0030084, filed Feb. 29, 2024, the entire contents of which is incorporated herein for all purposes by this reference.

### BACKGROUND OF THE INVENTION

### Field of the Invention

The present invention relates to an integrated control system for a vehicle, and more particularly, to an integrated control system capable of controlling both a refrigerant module and a coolant module included in the vehicle in an integrated manner.

### Description of the Related Art

Typically, the engine and transmission of a vehicle operate at high temperatures due to heat generated from fuel combustion and friction in various moving parts. To cool these high-temperature engine and transmission components, a coolant passage is formed, and a thermostat is used to adjust the coolant flow for the rapid warm-up of a cold engine. A radiator is installed to dissipate the heat from the coolant. Cooling fans are used to enhance the heat exchange efficiency of the radiator.

The coolant passage, designed for managing the temperature of the engine and transmission, is typically equipped with a valve device that is controlled by an externally installed controller, enabling temperature management. The coolant pump is also connected to and controlled by the controller, which is generally either integrated within a housing or separately connected via wires outside the housing.

FIG. 1 illustrates the configuration of a conventional control system for refrigerant module and coolant module.

With reference to FIG. 1, the conventional control system includes a control module 1000, a coolant module 2000, and a refrigerant module 3000, with the control module 1000 comprising a higher-level controller 1100 and lower-level controllers 1200. The higher-level controller 1100 sends higher-level control signals to the lower-level controllers 1200 to control the coolant module 2000 and refrigerant module 3000, while the lower-level controllers 1200 send lower-level control signals based on the higher-level control signals to the respective electrical components of the coolant module 2000 and refrigerant module 3000. That is, the conventional control system used individual lower-level controllers 1200 to independently control electrical components, such as the electric water pump (EWP), multi-valve for coolant (Multi V/V), and electronic expansion valve (EXV), within the coolant module 2000 and refrigerant module 3000.

This conventional control system requires software development for each lower-level controller 1200, leading to increased costs associated with signal verification. Additionally, software updates had to be performed individually for each controller 1200, resulting in significant time and cost expenditures and limited software reusability.

### SUMMARY OF THE INVENTION

The present invention has been conceived to solve the above problems and it is an object of the present invention to provide an integrated control system capable of controlling the end devices of the connected coolant module and refrigerant module using a single control module.

According to an aspect of the present invention, an integrated control device for controlling at least one of a refrigerant module and a coolant module in a vehicle includes at least one driving module each connected to at least one end device included in the refrigerant module and the coolant module and configured to drive the end device, and a control module configured to transmit control signals to each driving module to control each end device, wherein the control module receives a higher-level control command from a higher-level controller of the vehicle and, based on the higher-level control command, transmits the control signals to each driving module.

According to an embodiment, the driving module is configured to be code-free and drive the end device based on the control signal received from the control module.

According to an embodiment, the end device includes at least one of an electric water pump (EWP), a multi-valve for coolant (Multi V/V), an expansion valve, a water heater, or an electric compressor.

According to an embodiment, at least one of the multi-valve for coolant or the electronic expansion valve is directly connected to the control module for communication.

According to an embodiment, the driving module includes at least one metal-oxide-semiconductor field-effect transistor (MOSFET) connected to the EWP (Electric Water Pump) and the multi-valve for coolant (Multi V/V).

According to an embodiment, the control module determines the end devices to which the control signals are to be transmitted based on the higher-level control command received from the higher-level controller, and transmits the control signals to the driving modules connected to the determined end devices.

According to an embodiment, the control module distinguishes the end devices to which the control signals are to be transmitted based on the pre-stored identifiers (IDs) of the end devices.

According to an embodiment, the control module transmits the control signals to each driving module based on the surrounding environment information received from a sensing unit of the vehicle.

According to an embodiment, the surrounding environment information includes at least one of atmospheric pressure information, temperature information, and coolant level information.

According to an embodiment, the control module determines the end devices to which the control signals are to be transmitted based on the surrounding environment information received from the sensing unit, and transmits the control signals to the driving modules connected to the determined end devices.

According to an embodiment, the control module distinguishes the end devices to which the control signals are to be transmitted based on the pre-stored identifiers (IDs) of the end devices.

The integrated control device further includes a power source connector connected to an external power source, a coolant module connector connected to the coolant module, and a refrigerant module connector connected to the refrigerant module.

### BRIEF DESCRIPTION OF THE DRAWINGS

FIG. 1 is a diagram illustrating the configuration of a conventional control system for refrigerant module and coolant module;

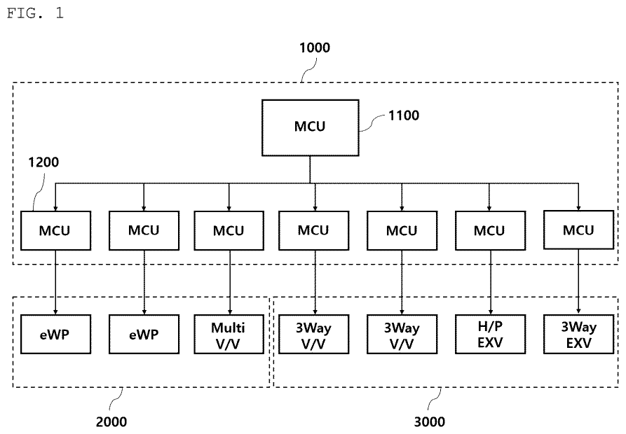

FIG. 2 is a perspective view illustrating the assembled configuration of the integrated control system according to an embodiment of the present invention;

FIG. 3 is a perspective view illustrating the configuration of the integrated control device according to an embodiment of the present invention; and

FIG. 4 is a diagram illustrating the integrated control system including the integrated control device according to an embodiment of the present invention.

### DETAILED DESCRIPTION OF THE INVENTION

The foregoing objectives, features, and advantages of the present invention will be more clearly understood through the following detailed description, taken in conjunction with the accompanying drawings. The specific structural or functional descriptions below are merely illustrative examples intended to describe embodiments of the present invention, and the embodiments of the present invention may be implemented in various forms and should not be construed as limited to those described in this specification or the application. The embodiments of the present invention may be subject to various modifications and may take on many different forms; therefore, specific embodiments are illustrated in the drawings and described in detail in this specification or the application. However, this should not be construed as limiting the embodiments of the present invention to the specific disclosed form, but should rather be understood to encompass all modifications, equivalents, or substitutes that fall within the scope of the concept and technological scope of the disclosure. The terms such as “first” and/or “second” may be used to describe various components, but the components are not limited to these terms. These terms are used in solely for the purpose of distinguishing one component from another, so that, for example, the first component may be referred to as the second component without departing from the scope of the present invention, and similarly, the second component may also be referred to as the first component. When it is stated that a component is connected to or coupled to another component, it should be understood that the component may be directly connected to or coupled to the other component, or there may be other components interposed therebetween. On the other hand, when it is stated that a component is directly connected to or coupled with another component, it should be understood that there are no intermediate components between them. Other expressions used to describe the relationship components, such as “between” and “directly between,” or “adjacent to” and “directly adjacent to,” should be interpreted in the same manner. The terms used in this specification are merely for the purpose of describing specific embodiments and are not intended to limit the present invention. The singular forms are intended to include the plural forms as well unless the context clearly indicates otherwise. The terms “include” or “comprise” used in this specification are intended to specify the presence of the described features, numbers, steps, actions, components, parts, or combinations thereof, and should not be understood as excluding the possibility of additional features, numbers, steps, actions, components, parts, or combinations thereof. Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein. To provide a detailed explanation of the present invention, preferred embodiments thereof will hereinafter be described with reference to the accompanying drawings. Like reference numerals refer to like elements throughout the drawings.

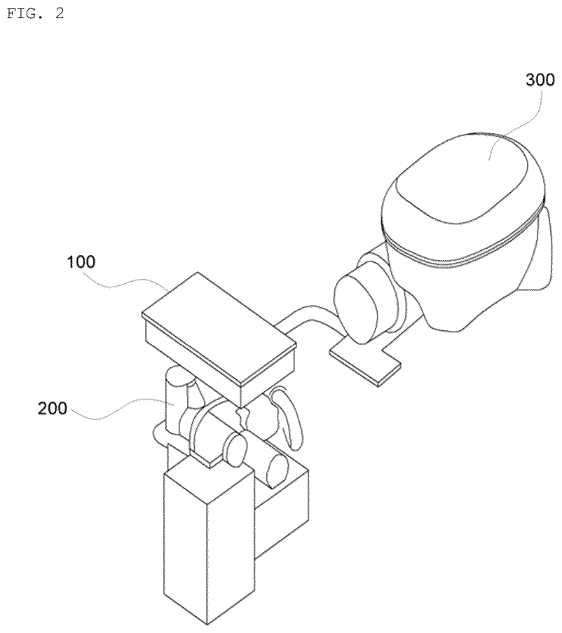

FIG. 2 is a perspective view illustrating the assembled configuration of the integrated control system according to an embodiment of the present invention.

With reference to FIG. 2, the integrated control device 100 according to an embodiment of the present invention may be coupled to the refrigerant module 200 and connected to an external power source, refrigerant module 200, and coolant module 300. Here, the external power source may be an internal vehicle battery.

The integrated control device 100 is coupled to the refrigerant module 200 in a detachable manner, preferably at the top of the refrigerant module 200. Additionally, the integrated control device 100 is electrically connected to the external power source, refrigerant module 200, and coolant module 300, enabling control of the refrigerant module 200 and coolant module 300. The integrated control device 100 may include connectors for electrical connections to the external power source, refrigerant module 200, and coolant module 300. The connectors of the integrated control device 100 may be positioned close to each device (external power source, refrigerant module 200, and coolant module 300) to facilitate easy detachment.

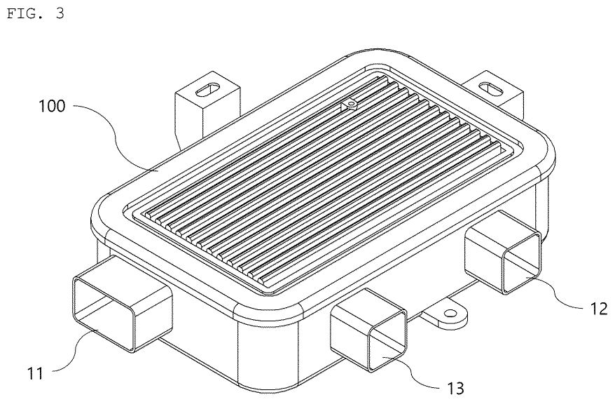

Hereinafter, the configuration of the integrated control unit 100 will be described in more detail with reference to FIG. 3. FIG. 3 is a perspective view illustrating the configuration of the integrated control device according to an embodiment of the present invention.

With reference to FIG. 3, the integrated control device 100 according to an embodiment of the present invention includes a rectangular-shaped case, which may include a power source connector 12 for connecting to an external power source, a coolant module connector 13 for connecting to the coolant module 300, and a refrigerant module connector 11 for connecting to the refrigerant module 200. The power source connector 12 and coolant module connector 13 may be formed on one side of the case, spaced apart by a predetermined distance and arranged in parallel. In this case, the side of the case where the power source connector 12 and coolant module connector 13 are formed may be oriented in the direction facing the coolant module 300. That is, the coolant module connector 13 is positioned in the direction where the coolant module 300 is placed, allowing for easier connection to the coolant module 300.

The refrigerant module connector 11 included in the case may be formed on a different side, adjacent to the side where the power source connector 12 and coolant module connector 13 are located. That is, the refrigerant module connector 11 may be formed on the side of the case and connected to the refrigerant module 200. This arrangement reduces the risk of wire entanglement and facilitates easy detachment when connecting the integrated control device 100 to the external power source, refrigerant module 200, and coolant module 300.

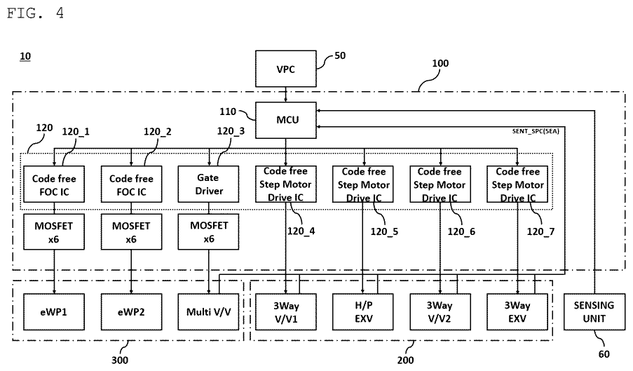

FIG. 4 is a diagram illustrating the integrated control system including the integrated control device according to an embodiment of the present invention.

With reference to FIG. 4, the integrated control system according to an embodiment of the present invention includes an integrated control device 100, a refrigerant module 200, and the coolant module 300, and the integrated control device 100 may include a control module 110 and driving modules 120_1, 120_2, 120_3, 120_4, 120_5, 120_6, and 120_7.

The driving modules 120_1, 120_2, 120_3, 120_4, 120_5, 120_6, and 120_7 may be connected to the respective end devices of the refrigerant module 200 and coolant module 300. The end devices of the refrigerant module 200 and coolant module 300 may include an electric water pump (EWP), a multi-valve for coolant (Multi V/V), an electronic expansion valve, and the like. The driving modules 120_1, 120_2, 120_3, 120_4, 120_5, 120_6, and 120_7 may be connected to end devices such as a coolant heater and an electric compressor, depending on the embodiment. The driving modules 120_1, 120_2, 120_3, 120_4, 120_5, 120_6, and 120_7, as driver ICs, supply power to the end devices of the refrigerant module 200 and the coolant module 300, while also controlling the end devices based on control signals received from the control module 110. The driving modules 120_1, 120_2, 120_3, 120_4, 120_5, 120_6, and 120_7 may be code-free driver ICs, such as an application specific integrated circuit (ASIC) logic IC, which does not require separate software code. That is, the driving modules 120_1, 120_2, 120_3, 120_4, 120_5, 120_6, and 120_7 may control the end devices of the refrigerant module 200 and the coolant module 300 based on control signals received from the control module 110, rather than generating separate control signals for the end devices.

The driving modules 120_1, 120_2, and 120_3, which are connected to the end devices of the coolant module 300, such as the electric water pump (EWP) and the multi-valve for coolant (Multi V/V), among the driving modules 120_1 to 120_7, may include at least one metal-oxide-semiconductor field-effect transistor (MOSFET) to facilitate the connection. That is, the driving modules 120_1, 120_2, and 120_3, which are connected to high-power-consuming devices like the EWP and the coolant multi-valve, may provide appropriate power by incorporating MOSFETs.

Furthermore, the driving modules 120_1, 120_2, 120_3, 120_4, 120_5, 120_6, and 120_7 may include field oriented control (FOC) ICs 120_1 and 120_2 connected to the EWP, a gate driver 120_3 connected to the multi-valve for coolant (Multi V/V), and step motor driver ICs 120_4, 120_5, 120_6, and 120_7 connected to the refrigerant module valves.

The control module 110 may transmit control signals to the respective driving modules 120_1, 120_2, 120_3, 120_4, 120_5, 120_6, and 120_7 to control the plurality of end devices. The control module 110 receives a higher-level control command from the higher-level controller 50 of the vehicle and, based on the higher-level control command, transmits control signals to each of the driving modules 120_1, 120_2, 120_3, 120_4, 120_5, 120_6, and 120_7. Here, the higher-level controller 50 may be, for example, a vehicle platform controller (VPC).

The control module 110 may determine the end devices of the refrigerant module 200 and coolant module 300 based on the higher-level control command received from the higher-level controller 50. The control module 110, once the end devices of the refrigerant module 200 and coolant module 300, to which control signals have been transmitted, are identified, may transmit control signals to the driving modules 120_1, 120_2, 120_3, 120_4, 120_5, 120_6, and 120_7 connected to those end devices. Here, the control module 110 may be directly connected to the end devices (such as the multi-valve for the coolant module (Multi V/V) and the valves for the refrigerant module 200) for communication, and may acquire the IDs of the end devices from the end devices and the higher-level controller 50. The control module 110 may, for example, be connected to the multi-valve for the coolant module and the valve for the refrigerant module using a single edge nibble transmission short pulse width modulation (PWM) code (SENT SPC) communication method. Based on the pre-stored identifiers (IDs) of the end devices of the refrigerant module 200 and the coolant module 300, the control module 110 may transmit control signals to the driving modules 120_1, 120_2, 120_3, 120_4, 120_5, 120_6, and 120_7 assigned to the IDs of the end devices that require control.

The control module 110 may also transmit control signals to each of the driving modules 120_1, 120_2, 120_3, 120_4, 120_5, 120_6, and 120_7 based on surrounding environment information received from the sensing unit 60 of the vehicle. The sensing unit 60 may include, for example, at least one of a pressure sensor, a temperature sensor, and a coolant level sensor, and the surrounding environment information may include at least one of atmospheric pressure information, temperature information, and coolant level information. The control module 110 may determine the end devices of the refrigerant module 200 and coolant module 300 to which control signals are to be transmitted, based on the surrounding environment information received from the sensing unit 60. The control module 110, once the end devices of the refrigerant module 200 and coolant module 300, to which control signals have been transmitted, are identified, may transmit control signals to the driving modules 120_1, 120_2, 120_3, 120_4, 120_5, 120_6, and 120_7 connected to those end devices. Here, the control module 110 may transmit control signals to the driving modules 120_1, 120_2, 120_3, 120_4, 120_5, 120_6, and 120_7 assigned to the IDs of the end devices requiring control, based on the pre-stored IDs of the end devices of the refrigerant module 200 and coolant module 300.

The present invention is advantageous in terms of reducing the number of circuit components by controlling the refrigerant module and coolant module using a single control module.

The present invention is also advantageous in terms of reducing PCB manufacturing costs and weight due to the reduction in circuit components.

The present invention is also advantageous in terms of facilitating software installation and updates due to the use of the single control module.

The present invention is also advantageous in terms of reducing testing costs such as those for ES and EMC due to the use of the single control module.

The present invention is also advantageous in terms of improving reusability by integrally controlling the refrigerant module and coolant module through the integrated control module.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

10: integrated control system
11: refrigerant module connector
12: power source connector
13: coolant module connector
50: higher-level controller
60: sensing unit
100: integrated control device
110: control module
120 (120_1, 120_2, . . . , 120_7): driving module
200: refrigerant module
300: coolant module

What is claimed is:

1. An integrated control device for controlling at least one of a refrigerant module and a coolant module in a vehicle, the device comprising:
at least one driving module each connected to at least one end device included in the refrigerant module and the coolant module and configured to drive the end device; and
a control module configured to transmit control signals to each driving module to control each end device,
wherein the control module receives a higher-level control command from a higher-level controller of the vehicle and, based on the higher-level control command, transmits the control signals to each driving module.

2. The device of claim 1, wherein the driving module is configured to be code-free and drive the end device based on the control signal received from the control module.

3. The device of claim 2, wherein the driving module comprises an application specific integrated circuit (ASIC) logic IC that operates without the need for separate software code.

4. The device of claim 1, wherein the end device comprises at least one of an electric water pump (EWP), a multi-valve for coolant (Multi V/V), an expansion valve, a water heater, or an electric compressor.

5. The device of claim 4, wherein the driving module comprises at least one of a field oriented control (FOC) IC, a gate driver connected to the multi-valve for coolant (Multi V/V), or a step motor driver IC connected to the refrigerant module valves.

6. The device of claim 4, wherein at least one of the multi-valve for coolant or the electronic expansion valve is directly connected to the control module for communication.

7. The device of claim 5, wherein the driving module comprises at least one metal-oxide-semiconductor field-effect transistor (MOSFET) connected to the EWP (Electric Water Pump) and the multi-valve for coolant (Multi V/V).

8. The device of claim 1, wherein the control module determines the end devices to which the control signals are to be transmitted based on the higher-level control command received from the higher-level controller, and transmits the control signals to the driving modules connected to the determined end devices.

9. The device of claim 8, wherein the control module distinguishes the end devices to which the control signals are to be transmitted based on the pre-stored identifiers (IDs) of the end devices.

10. The device of claim 9, wherein the control module is connected to the end devices using a single edge nibble transmission short pulse width modulation (PWM) code (SENT_SPC) communication method.

11. The device of claim 1, wherein the control module transmits the control signals to each driving module based on the surrounding environment information received from a sensing unit of the vehicle.

12. The device of claim 11, wherein the surrounding environment information comprises at least one of atmospheric pressure information, temperature information, and coolant level information.

13. The device of claim 11, wherein the control module determines the end devices to which the control signals are to be transmitted based on the surrounding environment information received from the sensing unit, and transmits the control signals to the driving modules connected to the determined end devices.

14. The device of claim 13, wherein the control module distinguishes the end devices to which the control signals are to be transmitted based on the pre-stored identifiers (IDs) of the end devices.

15. The device of claim 1, wherein the higher-level controller comprises a vehicle platform controller (VPC).

16. The device of claim 1, further comprising:
a power source connector connected to an external power source;
a coolant module connector connected to the coolant module; and
a refrigerant module connector connected to the refrigerant module.
